(19) United States
(12) Patent Application Publication
(10) Pub. No.: US 2005/0022215 A1
(43) Pub. Date: Jan. 27, 2005

(54) Apparatus for loading disc cartridge

(75) Inventor: Dong-man Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-city (KR)

(21) Appl. No.: 10/722,564

(22) Filed: Nov. 28, 2003

(30) Foreign Application Priority Data
Jul. 22, 2003 (KR) 2003-50265

(51) Int. Cl. G11B 33/02

(52) U.S. Cl. 720/601; 720/631

(57) ABSTRACT

A disc cartridge to be accommodated on a tray in a drive includes, a surface having a reference area and a low area concavely formed lower than the reference surface to have a predetermined step. An apparatus for loading the cartridge includes an interference portion protruding on an upper surface of the tray to have a height corresponding to the step. The interference portion contacts an area which does not belong to a range in which the shutter moves in the low area of the disc cartridge when the disc cartridge is normally inserted, and the interference portion interferes with the reference area when the disc cartridge is inserted in a reverse direction.

### CROSS-REFERENCE TO RELATED APPLICATION

This application claims the benefit of Korean Patent Application No. 2003-50265 filed on Jul. 22, 2003 in the Korean Intellectual Property Office, the disclosure of which is incorporated herein in its entirety by reference.

### BACKGROUND OF THE INVENTION

1. Field of the Invention

The present invention relates to an apparatus for accommodating a disc cartridge and loading the disc cartridge in a drive, and more particularly, to a loading apparatus which has a mechanism that prevents loading the disc cartridge in a reverse direction.

2. Description of the Related Art

In general, a disc drive includes a main body that includes an optical pickup that performs recording and/or reproduction with respect to a disc, a loading apparatus to accommodate a disc cartridge and to load the disc cartridge in the main body, and a cover to cover the main body. When the disc cartridge is accommodated on the tray and the tray is pushed into the main body, a shutter of the disc cartridge is opened inside the main body so that the optical pickup can access the disc in the disc cartridge.

In order to perform the above-described normal operation, the cartridge must be inserted so that a portion of the disc cartridge having the shutter enters first. If a user inserts the disc cartridge back to the front (i.e., in a reverse direction in which the shutter enters last), both elements in the main body and the disc cartridge may be severely damaged.

### SUMMARY OF THE INVENTION

To solve the above and/or other problems, the present invention provides a loading apparatus which has a mechanism to prevent the disc cartridge from being inserted in a reverse direction.

Additional aspects and/or advantages of the invention will be set forth in part in the description which follows and, in part, will be obvious from the description, or may be learned by practice of the invention.

According to an aspect of the present invention, a disc cartridge comprises a shutter capable of opening/shutting at one side of the disc cartridge, and an area where the shutter is installed is concavely formed corresponding to a thickness of the shutter.

According to an aspect of the present invention, the disc cartridge has a step between a low area at the side where the shutter is installed and a remaining area including a reference area, where the low area includes a movement range during opening/shutting of the shutter, and an area irrelevant to the movement range.

According to an aspect of the present invention, when the disc cartridge is to be inserted in a reverse direction, the reverse insertion of the disc cartridge is prevented in advance to avoid malfunction by the step on the surface of the disc cartridge, which prevents a reverse insertion of the disc cartridge.

According to an aspect of the present invention, a protruding portion having a height corresponding to the step of the disc cartridge is formed on an upper surface of the tray at a position corresponding to an area that is not included in the movement range of the shutter of the low area of the disc cartridge when the disc cartridge is normally inserted.

According to an aspect of the present invention, the protruding portion is formed to overlap the reference area when the disc cartridge is inserted in a reverse direction.

According to an aspect of the present invention, when the disc cartridge is inserted in the reverse direction, one side of the disc cartridge is lifted by the protruding portion.

According to an aspect of the present invention, the one side of the disc cartridge is lifted by the protruding portion such that the disc cartridge is caught by an upper portion of a tray inlet of the main body and the disc cartridge is not loaded so as to prevent a damage due to a malfunction.

According to an aspect of the present invention, the protruding portion can be formed to have a predetermined area in a corresponding area or a shape of a protrusion.

### BRIEF DESCRIPTION OF THE DRAWINGS

These and/or other features and advantages of the invention will become apparent and more readily appreciated by describing in detail embodiments thereof with reference to the accompanying drawings in which:

FIG. 1 is an exploded perspective view illustrating a disc drive using a loading apparatus according to an embodiment of the present invention; and

FIGS. 2A and 2B show holding states when the disc cartridge is inserted with front and rear sides and reversed front and rear sides according to an embodiment of the invention.

### DETAILED DESCRIPTION OF THE EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

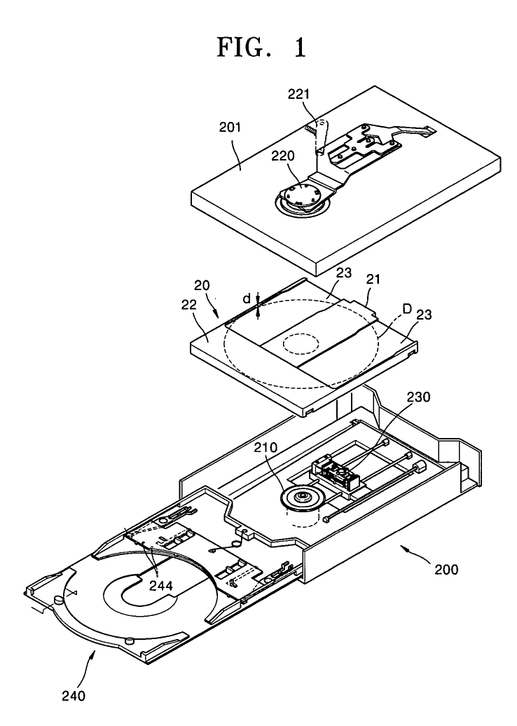

Referring to FIG. 1, a disc drive using a loading apparatus according to an aspect of the present invention includes a main body 200. The main body 200 includes a turntable on which a disc D is accommodated and an optical pickup 230 that records and/or reproduces with respect to the disc D. The main body further includes a tray 240 to accommodate a cartridge 20 containing the disc D and which loads the cartridge 20 in the main body 200, and a cover 201 that covers the main body 200. An opening lever 221 opening and shutting a shutter 21 of the cartridge 20 and a damper 220 clamping the disc D onto the turntable 210 are installed on the cover 201. While not shown, the tray 240 can accommodate the disc D without the cartridge 20. Additionally, while shown in FIG. 1 as being a two-sided cartridge housing dual sided disc D having dual recording surfaces, it is understood that the cartridge 20 can be a single sided cartridge 20. Further, while shown in the context of an optical disc drive, it is understood that the disc D can be other than an optical disc, such as a magnetic disc or other information media used in a drive. It is further understood that the optical disc can be Compact Discs (CDs), Digital Versatile Discs (DVDs), Blue Ray Discs (BDs), Advances Optical Discs (AODs), and recordable versions thereof.

According to an aspect of the invention, the tray 240 includes an interference protrusion 244. The interference protrusion 244 formed on the tray 240 is provided as a unit that prevents the reverse insertion of the front and rear surfaces of the cartridge 20. Specifically, the cartridge 20 includes a low area 23 that is a step d lower than a reference area 22. According to an aspect of the invention, the step d of the low area is as large as a thickness of the shutter 21 so that the shutter 21 can slide without hindrance within the low area 23. That is, part of the disc cartridge 20 having the shutter 21 is formed to have a step d depth, which is as deep as the thickness of the shutter 21 so that the shutter 21 can slide in the low area 23. However, instead of having a low area 23 with a consistent depth d, it is understood that the low area 23 can have portions that are lower or higher than the step d area in which the shutter 21 moves.

According to an aspect of the invention, the interference protrusion 244 on the tray 240 has a height that is the same as or slightly smaller than the depth d of the step. The interference protrusion 244 is not in an area of the tray 240 corresponding to a portion of the low area 23 that would prevent the opening and shutting of the shutter 21. The interference protrusion 244 is shown formed in an area close to the reference area 22 when the disc cartridge 20 is accommodated on the tray 240 in a reverse direction.

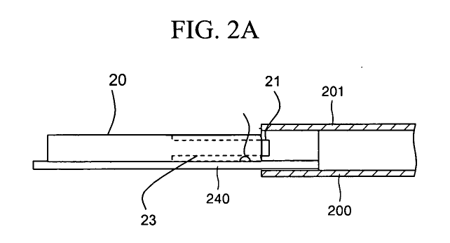

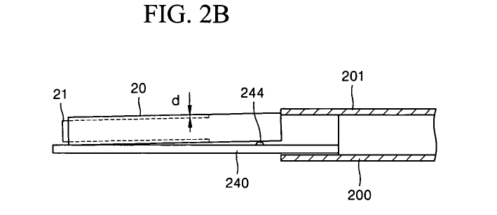

When the cartridge 20 is successfully accommodated on the tray 240 as shown in FIG. 2A, since the interference protrusion 244 is disposed in the low area 23 formed by the step d in the cartridge 20, the cartridge 20 does not interfere with the interference protrusion 244. Thus, the tray 240 can be loaded into the main body 200. However, when the cartridge 20 is accommodated on the tray 240 as the front and back sides of the cartridge 20 are reversed, as shown in FIG. 2B, the cartridge 20 is lifted by interfering with the interference protrusion 244. In this state, even if there is an attempt to forcibly insert the tray 240 into the main body 200, since the upper portion of the cartridge 20 contacts the cover 201, the tray 240 cannot be inserted. Therefore, when the front and rear sides of the cartridge 20 are reversed, the cartridge 20 cannot be inserted into the main body 200 due to interference with the interference protrusion 244. In contrast, when the front and rear sides are correctly inserted as shown in FIG. 2A, the cartridge 20 does not interfere with the interference protrusion 244, and the cartridge 20 does not contact the cover 201 so as to allow insertion.

It is understood that the protrusion 244 could be placed in other locations according to other aspects of the invention. Additionally, while shown as a protrusion 244, it is understood that ridges or stepped areas could be used to form a protruding area that similarly interacts with the reference area 22 when the disc cartridge 20 is inserted incorrectly but which receives the low area 23 when the disc cartridge 20 is correctly inserted. It is further understood that protrusions 244 could be on the cartridge 20 with the corresponding low area 23 being on the tray 240. Also, it is understood that the low area 23 could be a groove or opening into which the protrusions 244 are received without forming a common surface with the area in which the shutter 21 moves.

While described in terms of a tray 240, it is understood that the present invention could be used with a caddy that is removable from the main body 200. It is further understood that, instead of contacting the cover 201, a blocking element could be used to block the insertion of the cartridge 20. Such an element could be disposed on the cover 201, or elsewhere in the drive. Further, while shown as being raised above or below the tray 240, the protrusion 244 could instead force the cartridge 20 to a side so as to contact a blocking element on a side of the cover 201 instead of or in addition to being raised off of the tray 240.

As described above, in the tray for a disc drive according to the present invention, since the front/rear side reverse insertion prevention unit is provided, the cartridge is always inserted in a correct state so as to prevent damage to the apparatus due to mishandling.

Although a few embodiments of the present invention have been shown and described, it would be appreciated by those skilled in the art that changes may be made in this embodiment without departing from the principles and spirit of the invention, the scope of which is defined in the claims and their equivalents.

1. An apparatus for loading a disc cartridge in a drive, where the disc cartridge includes a shutter and a reference surface having a reference area and a low area formed in the reference surface to have a low surface below the reference surface to form a step therebetween, the apparatus comprising:
a tray to accommodate the disc cartridge and comprising an interference portion which protrudes from an upper surface of the tray to have a height corresponding to a height of the step; and
a blocking element disposed adjacent the tray at an opening into the drive,
wherein:
when the disc cartridge is received on the tray in a normal orientation, the interference portion is received within another portion of the low area without interfering with a movement of the shutter in the low area, and
when the disc cartridge is accommodated on the tray in an abnormal orientation, the interference portion contacts and interferes with the reference area such that the cartridge is blocked by the blocking element as the tray moves toward the opening of the drive.

2. The apparatus as claimed in claim 1, wherein the interference portion has a shape of a protrusion.

3. A housing for to accommodate and load a disc cartridge which holds a disc, the housing comprising:
a case having an opening and a blocking element; and
a tray on which the disc cartridge is accommodated at an accommodation position and which includes an interfering element that selectively aligns the disc cartridge into first and second orientations according to an interaction with corresponding first and second surfaces of the disc cartridge,
wherein:
if the disc cartridge is accommodated in the first orientation, the tray and the accommodated disc are received into the case through the opening, and
if the disc cartridge is accommodated in the second orientation other than the first orientation, the tray and the accommodated disc are blocked by the blocking element and are not received into the case through the opening.

4. The housing of claim 3, wherein:
the disc cartridge includes the first surface disposed at a first level and the second surface disposed at a second level other than the first level and forming a step therebetween,
when the disc cartridge is disposed in the first orientation at the accommodation position with the interfering element being received at the second surface, the tray is moveable past the blocking element into the opening, and
when the disc cartridge is disposed in the second orientation at the accommodation position with the interfering element being received at the first surface, the blocking element prevents the tray from entering the opening.

5. The housing of claim 3, wherein the interfering element allows the disc cartridge to remain substantially parallel with a surface of the tray when in the first orientation, and elevates a portion of the disc cartridge away from the surface of the tray so as to contact the blocking element to prevent entry into the opening when in the second orientation.

6. The housing of claim 3, wherein:
the disc cartridge further comprises a shutter that is moveable to allow access to the disc,
when accommodated on the tray in the first orientation, the shutter is disposed between the opening and the first surface, and
when accommodated on the tray in the second orientation, the first surface is disposed between the opening and the shutter.

7. The housing of claim 6, wherein the shutter moves within an area adjacent to and coplanar with the second surface.

8. The housing of claim 6, wherein the shutter moves within an area adjacent to the second surface at which the interfering element is not received.

9. The housing of claim 7, wherein the shutter moves within an area adjacent to the second surface at which the interfering element is not received.

10. The housing of claim 3, wherein:
the second surface comprises a recessed surface having a depth below the first surface; and
the interfering element has a height above a surface of the tray that is at or less than the depth of the recessed surface of the disc cartridge such that, when received in the first orientation, the disc cartridge is substantially parallel with the surface of the tray.

11. The housing of claim 10, wherein:
the blocking element is disposed over the surface of the tray by a first distance, and
when received in the second orientation, the interfering element contacts the first surface of the disc cartridge, and the height of the interfering element is sufficient to elevate a portion of the disc cartridge away from the surface of the tray by at least the first distance such that, during insertion into the opening, the elevated portion of the disc cartridge contacts the blocking element to prevent entry into the opening.

12. The housing of claim 3, further comprising a rail along which the tray is slidably received in the housing.

13. The housing of claim 3, further comprising an optical pickup unit to transfer data with respect to the disc.

14. The housing of claim 3, wherein the tray further comprises a disc accommodation area on which the tray receives another disc not within the disc cartridge.

15. The housing of claim 3, wherein:
when accommodated at the first orientation, a centerline of the disc cartridge is disposed at a first angle that is substantially parallel with a direction in which the tray is loaded into the case through the opening, and
when accommodated at the second orientation, the centerline of the disc cartridge is disposed to be sufficiently non-parallel with the direction so as misalign the disc cartridge to extend sufficiently away from the tray to contact the blocking element so as to prevent entry through the opening.
